(19) United States
(12) Patent Application Publication
(10) Pub. No.: US 2015/0237140 A1
(43) Pub. Date: Aug. 20, 2015

(54) DATA STORAGE SYSTEMS AND METHODS

(71) Applicant: Tenoware R&D Limited, Dublin (IE)

(72) Inventors: Kelly Murphy, Los Altos, CA (US); Antoni Sawicki, Mountain View, CA (US); Tomasz Nowak, San Jose, CA (US); Shri Ram Agarwal, Belmont, CA (US); Borislav Stoyanov Marinov, Trabuco Canyon, CA (US)

(21) Appl. No.: 14/624,390

(22) Filed: Feb. 17, 2015

Related U.S. Application Data
(60) Provisional application No. 61/940,247, filed on Feb. 14, 2014.

(51) Int. Cl. H04L 29/08; G06F 9/455; G06F 9/50

(52) U.S. Cl. CPC H04L 67/1097; G06F 9/5016; G06F 9/45558; G06F 2009/45579

(57) ABSTRACT

Example data storage systems and methods are described. In one implementation, one or more processors implement multiple virtual machines, each of which is executing an application. A virtual controller is coupled to the processors and manages storage of data received from the multiple virtual machines. Multiple I/O channels are configured to communicate data from the multiple virtual machines to a data storage node based on data storage instructions received from the virtual controller.

### CROSS REFERENCE TO RELATED APPLICATIONS

This application claims the benefit of U.S. Provisional Application Ser. No. 61/940,247, entitled “Server-Side Virtual Controller,” filed Feb. 14, 2014, the disclosure of which is incorporated herein by reference in its entirety.

### TECHNICAL FIELD

The present disclosure generally relates to data processing techniques and, more specifically, to systems and methods for storing and retrieving data.

### BACKGROUND

FIG. 1 is a block diagram depicting an existing storage system 100. In this system, multiple computing devices are coupled to a common storage controller 102 through one or more communication links 104. Storage controller 102 manages data read requests and data write requests associated with multiple storage devices via one or more communication links 106. The configuration of system 100 requires all data and data access requests to flow through the one storage controller 102. This creates a data bottleneck at storage controller 102.

Additionally, each computing device in system 100 includes an I/O Blender, which randomly mixes data produced by multiple applications running on the multiple virtual machines in the computing device. This random mixing of the data from different applications prevents storage controller 102 from optimizing the handling of this data, which can reduce the performance of applications running on all of the computing devices.

### BRIEF DESCRIPTION OF THE DRAWINGS

Non-limiting and non-exhaustive embodiments of the present disclosure are described with reference to the following figures, wherein like reference numerals refer to like parts throughout the various figures unless otherwise specified.

FIG. 1 is a block diagram depicting an existing storage system.

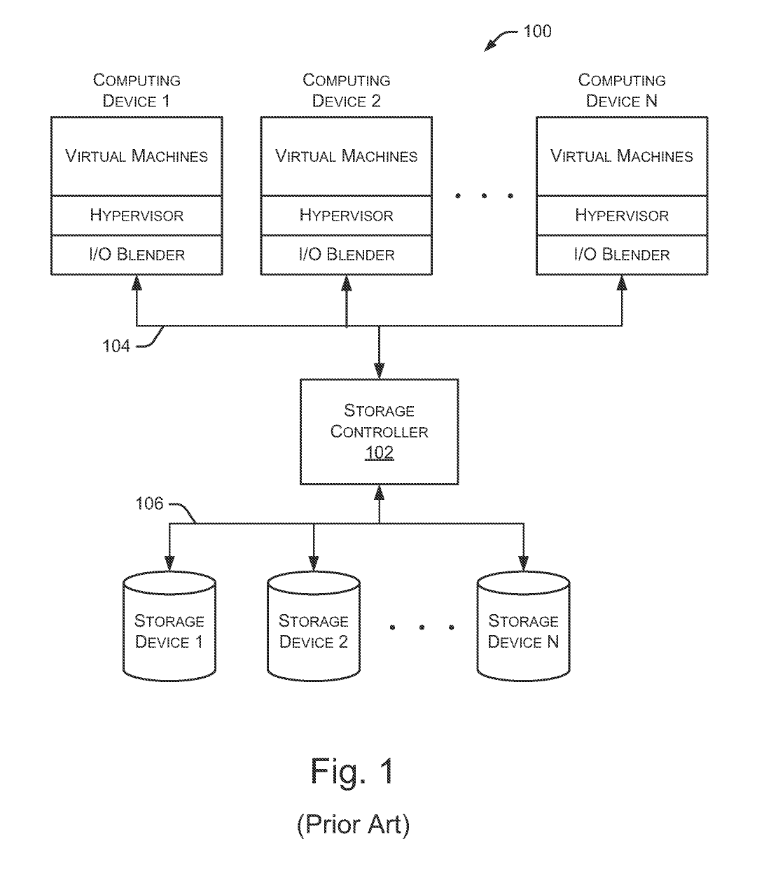

FIG. 2 is a block diagram depicting an embodiment of a data storage and retrieval system implementing a virtual controller.

FIG. 3 is a block diagram depicting an embodiment of a computing device including multiple virtual machines, a hypervisor, and a virtual controller.

FIG. 4 is a block diagram depicting an embodiment of a computing device that provides multiple quality of service (QOS) levels for writing data to, and retrieving data from, a shared storage system.

FIG. 5 is a block diagram depicting an embodiment of a data processing environment including multiple virtual storage pools.

FIG. 6 is a block diagram depicting an embodiment of a virtual storage pool.

FIG. 7 is a block diagram depicting an embodiment of a storage node controller and an associated virtual store that provide multiple QOS levels for writing and retrieving data.

FIG. 8 is a flow diagram depicting an embodiment of a method for managing the reading and writing of data.

FIG. 9 is a block diagram depicting an example computing device.

### DETAILED DESCRIPTION

In the following description, reference is made to the accompanying drawings that form a part thereof, and in which is shown by way of illustration specific exemplary embodiments in which the disclosure may be practiced. These embodiments are described in sufficient detail to enable those skilled in the art to practice the concepts disclosed herein, and it is to be understood that modifications to the various disclosed embodiments may be made, and other embodiments may be utilized, without departing from the scope of the present disclosure. The following detailed description is, therefore, not to be taken in a limiting sense.

Reference throughout this specification to “one embodiment,” “an embodiment,” “one example,” or “an example” means that a particular feature, structure, or characteristic described in connection with the embodiment or example is included in at least one embodiment of the present disclosure. Thus, appearances of the phrases “in one embodiment,” “in an embodiment,” “one example,” or “an example” in various places throughout this specification are not necessarily all referring to the same embodiment or example. Furthermore, the particular features, structures, databases, or characteristics may be combined in any suitable combinations and/or sub-combinations in one or more embodiments or examples. In addition, it should be appreciated that the figures provided herewith are for explanation purposes to persons ordinarily skilled in the art and that the drawings are not necessarily drawn to scale.

Embodiments in accordance with the present disclosure may be embodied as an apparatus, method, or computer program product. Accordingly, the present disclosure may take the form of an entirely hardware-comprised embodiment, an entirely software-comprised embodiment (including firmware, resident software, micro-code, etc.), or an embodiment combining software and hardware aspects that may all generally be referred to herein as a “circuit,” “module,” or “system.” Furthermore, embodiments of the present disclosure may take the form of a computer program product embodied in any tangible medium of expression having computer-usable program code embodied in the medium.

Any combination of one or more computer-usable or computer-readable media may be utilized. For example, a computer-readable medium may include one or more of a portable computer diskette, a hard disk, a random access memory (RAM) device, a read-only memory (ROM) device, an erasable programmable read-only memory (EPROM or Flash memory) device, a portable compact disc read-only memory (CDROM), an optical storage device, and a magnetic storage device. Computer program code for carrying out operations of the present disclosure may be written in any combination of one or more programming languages. Such code may be compiled from source code to computer-readable assembly language or machine code suitable for the device or computer on which the code will be executed.

Embodiments may also be implemented in cloud computing environments. In this description and the following claims, “cloud computing” may be defined as a model for enabling ubiquitous, convenient, on-demand network access to a shared pool of configurable computing resources (e.g., networks, servers, storage, applications, and services) that can be rapidly provisioned via virtualization and released with minimal management effort or service provider interaction and then scaled accordingly. A cloud model can be composed of various characteristics (e.g., on-demand self-service, broad network access, resource pooling, rapid elasticity, and measured service), service models (e.g., Software as a Service (“SaaS”), Platform as a Service (“PaaS”), and Infrastructure as a Service (“IaaS”)), and deployment models (e.g., private cloud, community cloud, public cloud, and hybrid cloud).

The flow diagrams and block diagrams in the attached figures illustrate the architecture, functionality, and operation of possible implementations of systems, methods, and computer program products according to various embodiments of the present disclosure. In this regard, each block in the flow diagrams or block diagrams may represent a module, segment, or portion of code, which comprises one or more executable instructions for implementing the specified logical function(s). It will also be noted that each block of the block diagrams and/or flow diagrams, and combinations of blocks in the block diagrams and/or flow diagrams, may be implemented by special purpose hardware-based systems that perform the specified functions or acts, or combinations of special purpose hardware and computer instructions. These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flow diagram and/or block diagram block or blocks.

The systems and methods described herein relate to virtual controllers and associated data storage components and systems. In some embodiments, these virtual controllers are located within a computing device, such as a client device or a server device. Accordingly, the described systems and methods may refer to “server-side virtual controllers” or “client-side virtual controllers,” which include any virtual controller located in any type of computing device, such as the computing devices discussed herein.

In particular embodiments, one or more processors implement multiple virtual machines such that each of the multiple virtual machines execute one or more applications. A virtual controller manages the storage of data received from the multiple virtual machines. Multiple I/O (Input/Output) channels are configured to communicate data from the multiple virtual machines to one or more storage devices based on data storage instructions received from the virtual controller. In some embodiments, the I/O is from a single virtual machine (VM) rather than being mixed with I/O from other virtual machines. Additionally, in some embodiments, each I/O is isolated and communicated over separate channels to the storage device. In particular embodiments, each I/O channel is given a priority based on classes assigned to the virtual machine. I/O from a particular virtual machine may have priority processing over I/O from other virtual machines. There are multiple different priorities that can be given to the I/O channels. In some embodiments, an I/O channel is also created for the hypervisor and used for its metadata operations. This I/O channel is typically given the highest priority.

In some embodiments, a virtual controller receives data from an application executed by a virtual machine and determines optimal data storage parameters for the received data based on the type of data. The virtual controller also determines a quality of service (QOS) associated with the application and communicates the received data to at least one storage device based on the optimal data storage parameters and the quality of service associated with the application.

In particular embodiments, I/O channels are prioritized at both ends of the channel (i.e., the channels extend from the application executed by the virtual machine into each of the storage devices or storage nodes that store data associated with the application). By controlling the I/O at both ends of the channel, intelligent I/O control can be applied to ensure that one virtual machine does not overburden the inbound network of a storage node (i.e., fills its queues past the point where the storage node can prioritize the inbound traffic).

In some embodiments, the storage side of the system controls the flow of I/O from multiple hypervisors, each of which is hosting multiple virtual machines. Since each virtual machine can have different priority levels, and virtual machines can move between hosts (i.e., computing devices), the storage side must be in a position to prioritize I/O from many virtual machines running across multiple hosts. This is achieved by having control at each end of the channel, and a process that runs above all channels to determine appropriate I/O scheduling for each virtual machine. The I/O channels continue across the network and into each storage node. The storage node side of the I/O channel has the same priority classes applied to them as the host side of the I/O channel.

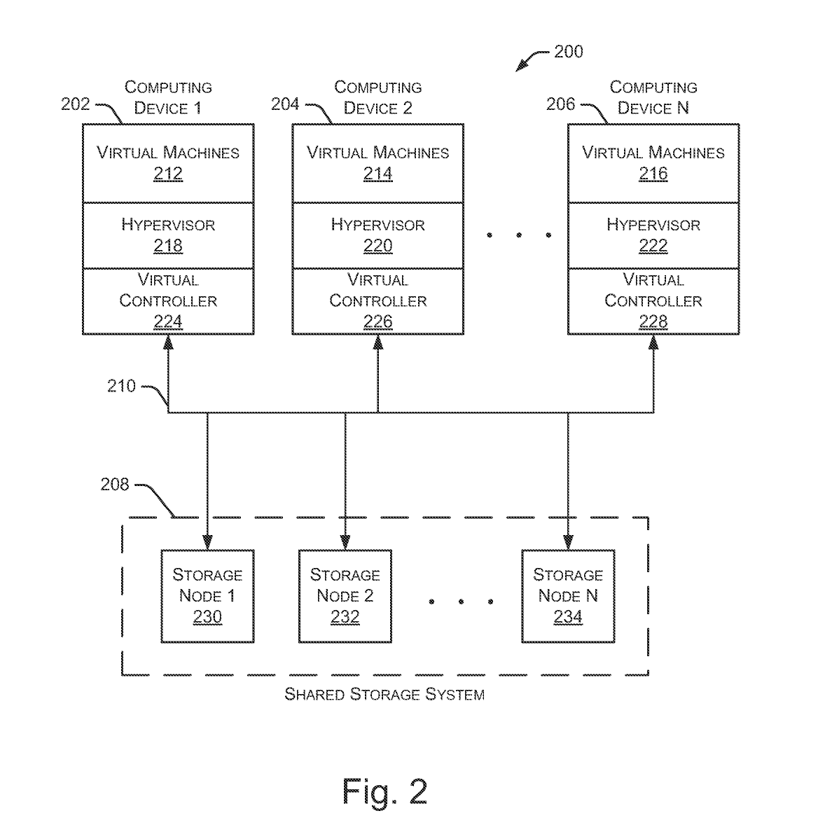

FIG. 2 is a block diagram depicting an embodiment of a data storage and retrieval system 200 implementing a virtual controller. System 200 includes computing devices 202, 204 and 206. Although three computing devices are shown in FIG. 2, alternate embodiments may include any number of computing devices. Computing devices 202-206 include any type of computing system, including servers, workstations, client systems, and the like. Computing devices 202-206 may also be referred to as “host devices” or “host systems.” Each computing device 202, 204, and 206 includes a group of virtual machines 212, 214, and 216, respectively. Each computing device 202-206 is capable of implementing any number of virtual machines 212-216. In some embodiments, each virtual machine executes an application that may periodically transmit and receive data from a shared storage system 208.

Each computing device 202, 204, and 206 includes a hypervisor 218, 220, and 222, respectively. Each hypervisor 218-222 creates, executes, and manages the operation of one or more virtual machines on the associated computing device. Each computing device 202, 204, and 206 also includes a virtual controller 224, 226, and 228, respectively. As discussed herein, virtual controllers 224-228 manage data read and data write operations associated with the virtual machines 212-216. In particular, virtual controllers 224-228 can handle input/output data (I/O) for each application running on a virtual machine. Since virtual controllers 224-228 understand the type of data (and the data needs) associated with each application, the virtual controllers can accelerate and optimize the I/O for each application. Additionally, since each computing device 202-206 has its own virtual controller 224-228, the number of supported computing devices can be scaled without significant loss of performance.

As shown in FIG. 2, virtual controllers 224-228 manage data read and write operations associated with data stored on shared storage system 208. Virtual controllers 224-228 communicate with shared storage system 208 via a data communication network 210 or other collection of one or more data communication links. Shared storage system 208 contains any number of storage nodes 230, 232, and 234. The storage nodes 230, 232, and 234 are also referred to as “storage devices” or “storage machines.” The storage nodes 230, 232, and 234 may be located in a common geographic location or distributed across a variety of different geographic locations and coupled to one another through data communication network 210.

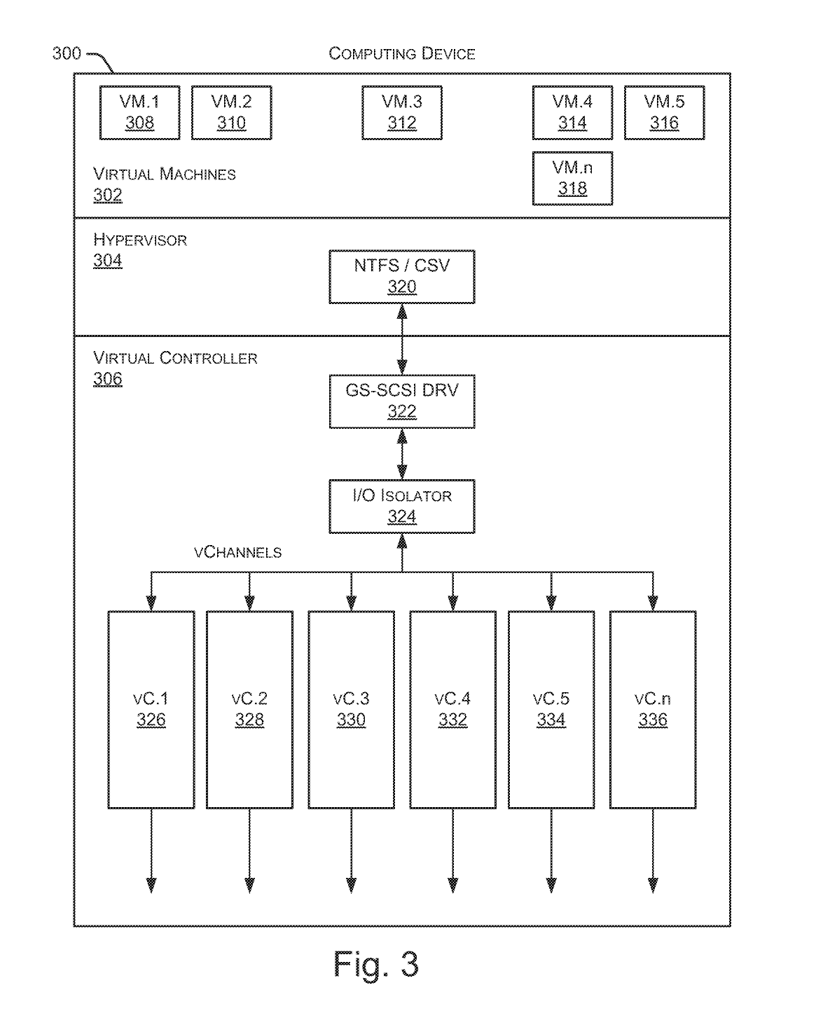

FIG. 3 is a block diagram depicting an embodiment of a computing device 300 including multiple virtual machines 302, a hypervisor 304, and a virtual controller 306. Computing device 300 represents any of the computing devices 202-206 discussed above with respect to FIG. 2. Virtual machines 302 may include any number of separate virtual machines. In the example of FIG. 3, seven virtual machines are shown: 308, 310, 312, 314, 316, and 318. Each virtual machine 308-318 may execute different applications or different instances of the same application.

Hypervisor 304 includes a NTFS/CSV module 320 which is an integral part of the operating system and provides a structured file system metadata and file input/output operations on a virtual store. In addition CSV provides a parallel access from plurality of host computers (e.g., computing devices) to a single shared virtual store allowing for Virtual Machine VHDX and other files to be visible and accessed from multiple hosts and virtual controllers simultaneously.

Virtual controller 306 includes a GS-SCSI DRV module 322 which is a kernel device driver providing access to the virtual store as a standard random access block device, visible to the operating system. The block device is formatted with NTFS/CSV file system. SCSI protocol semantics are used to provide additional capabilities required to share a block device by plurality of hosts in CSV deployment, such as SCSI Persistent Reservations.

Virtual controller 306 also includes an I/O isolator 324 which isolates (or separates) I/O associated with different virtual machines 308-318. For example, I/O isolator 324 will direct I/O associated with specific virtual machines to an appropriate virtual channel. As shown in FIG. 3, there are six virtual channels corresponding to each of the six virtual machines 308-318. The six virtual channels are assigned reference numbers 326, 328, 330, 332, 334, and 336. In this example, virtual channel 326 corresponds to I/O associated with virtual machine 308, virtual channel 328 corresponds to I/O associated with virtual machine 310, virtual channel 330 corresponds to I/O associated with virtual machine 312, virtual channel 332 corresponds to I/O associated with virtual machine 314, virtual channel 334 corresponds to I/O associated with virtual machine 316, and virtual channel 336 corresponds to I/O associated with virtual machine 318. As discussed herein, the six virtual channels are maintained on the shared storage system. Thus, rather than randomly storing all data from all applications running on virtual machines 308-318, the systems and methods described herein isolate the data from each application, using the virtual channels, and manage the storage of each application's data in the shared storage system. In some embodiments, data is tagged, labeled, or otherwise identified, as being associated with a particular virtual channel. In other embodiments, data may be tagged, labeled, or otherwise identified, as being associated with a particular quality of service level, discussed herein. For example, a particular block of data may have associated metadata that identifies a source virtual machine (or source application) and a quality of service level (or priority service level) associated with the block of data.

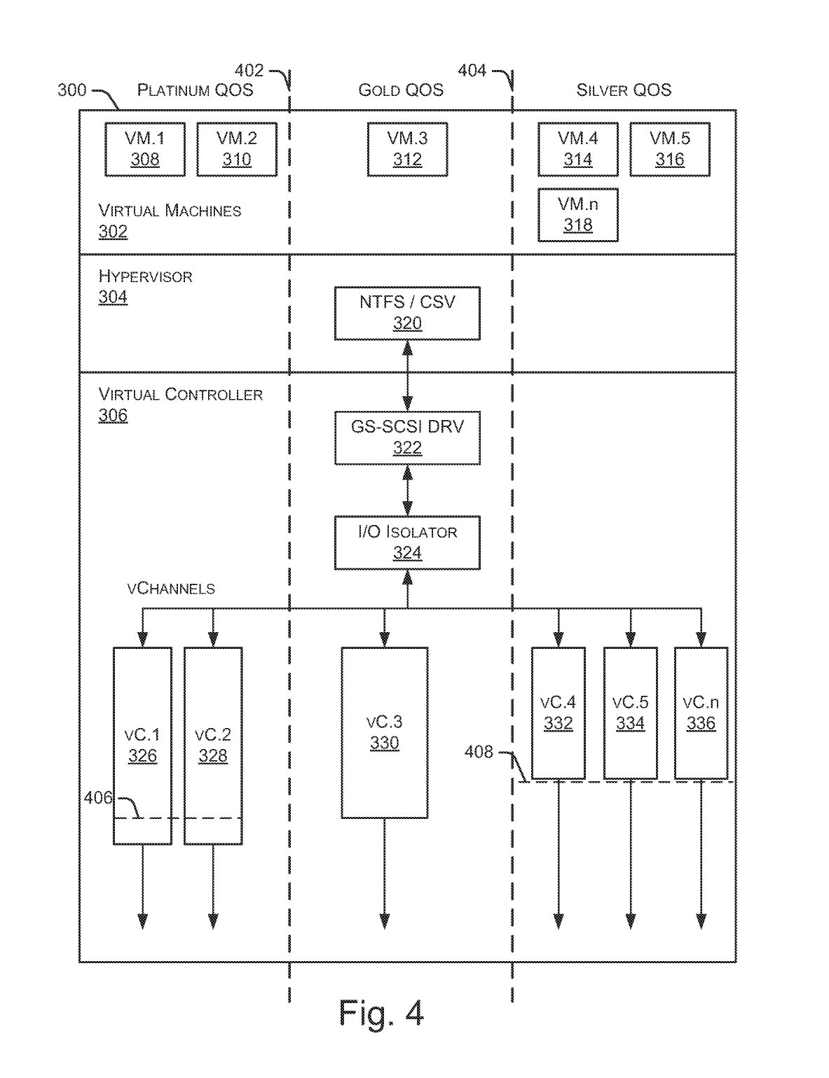

FIG. 4 is a block diagram depicting computing device 300 configured to provide multiple QOS levels for writing data to, and retrieving data from, a shared storage system. The various virtual machines, modules, and virtual channels shown in FIG. 4 correspond to similar virtual machines, modules, and virtual channels in FIG. 3 as noted by the common reference numbers. Additionally, FIG. 4 illustrates three different levels of quality of service provided to the virtual machines 308-318. Broken lines 402 and 404 identify the boundaries of the three quality of service levels. A platinum quality of service is shown to the left of broken line 402, a gold quality of service is shown between broken lines 402 and 404, and a silver quality of service is shown to the right of broken line 404. In this example, virtual machines 308 and 310 receive the platinum quality of service, virtual machine 312 receives the gold quality of service, and virtual machines 314, 316, and 318 receive the silver quality of service.

The platinum quality of service is the highest quality of service, ensuring highest I/O scheduling priority, expedited I/O processing, increased bandwidth, the fastest transmission rates, lowest latency and the like. The silver quality of service is the lowest quality of service and may receive, for example, less low scheduling priority, low bandwidth and lower transmission rates. The gold quality of service is in between the platinum and silver qualities of service.

Virtual channel 330, which receives the gold quality of service, has an assigned service level identified by the vertical height of virtual channel 330 shown in FIG. 4. Virtual channels 326 and 328 have a higher level of service, as indicated by the greater vertical height of the virtual channels 326 and 328 (as compared to the height of virtual channel 330). Broken line 406 indicates the amount of service provided to virtual channel 330 at the gold level. The additional service provided below broken line 406 indicates the additional (i.e., reserve) service capacity offered at the platinum quality of service level. Broken line 408 indicates that virtual channels 332-336 have shorter vertical heights (as compared to the height of virtual channel 330) because the silver quality of service is less than the gold quality of service level.

By offering different quality of service levels, more services and/or capacity are guaranteed for more important applications (i.e., the applications associated with the platinum quality of service level).

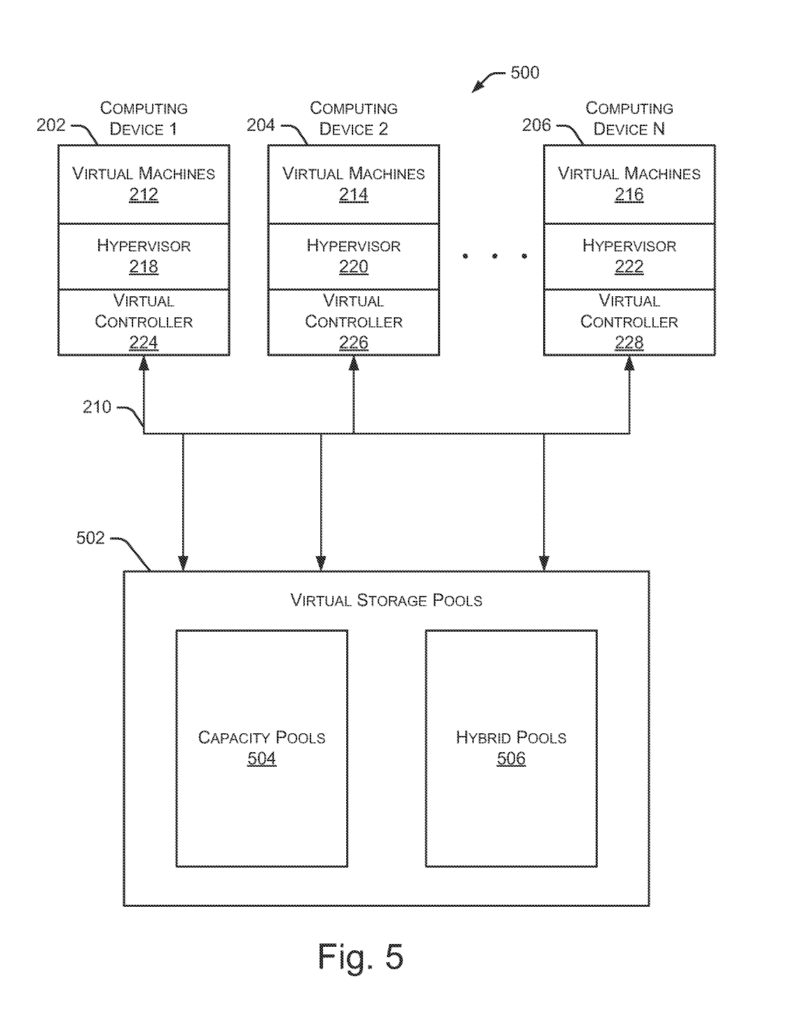

FIG. 5 is a block diagram depicting an embodiment of a data processing environment 500 including multiple virtual storage pools. In this example, the three computing devices 202-206, virtual machines 212-216, hypervisors 218-222, and virtual controllers 224-228 correspond to similar computing devices, virtual machines, hypervisors, and virtual controllers in FIG. 2 as noted by the common reference numbers. Computing devices 202-206 are coupled to a virtual storage pool 502 via data communication network 210. Virtual storage pool 502 may contain any number of storage nodes located at any number of different geographic locations. Virtual storage pool 502 includes one or more capacity pools 504 and one or more hybrid pools 506. The capacity pools 504 and hybrid pools 506 contain various types of storage devices, such as hard disk drives, flash memory devices, and the like. Capacity pools 504 are optimized for slower access but higher disk capacity, utilizing spinning hard disk media. Hybrid pools 506 utilize very fast and low latency flash memory disks as cache for the capacity pools 504 hard disks, thereby allowing higher access speeds to more demanding workloads.

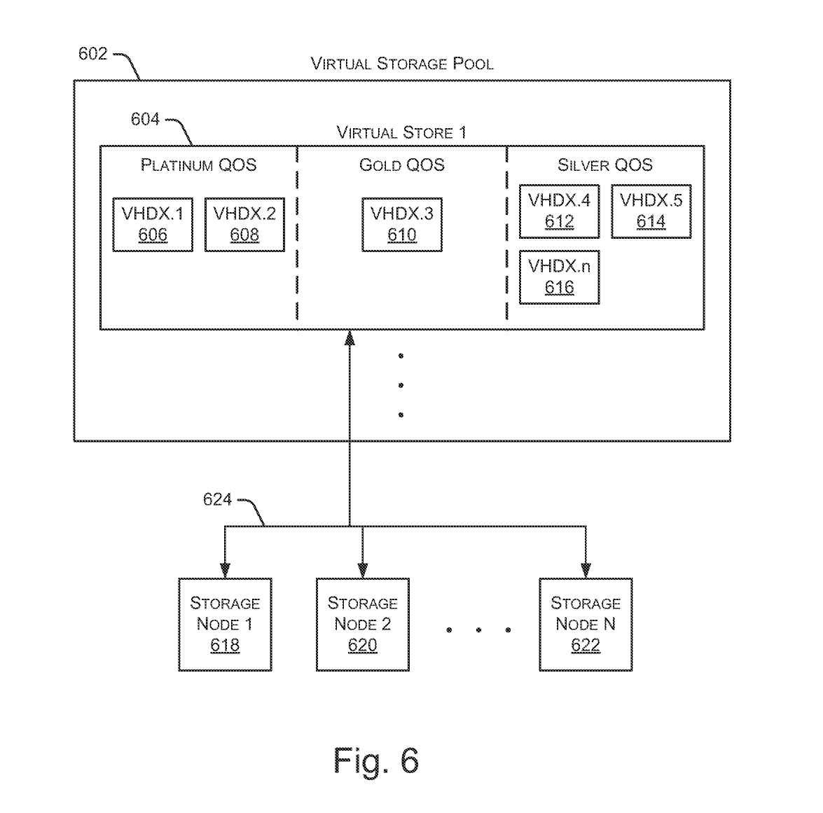

FIG. 6 is a block diagram depicting an embodiment of a virtual storage pool 602, which includes multiple virtual stores 604. Although one virtual store 604 is shown in FIG. 6, alternate virtual storage pools may include any number of virtual stores. Virtual store 604 includes six Hyper-V virtual hard disk (VHDX) modules 606, 608, 610, 612, 614, and 616 that correspond to the six virtual machines 610, 612, 614, and 616 that correspond to the six virtual machines 308-318 discussed herein. Although VHDX modules are shown in this example, alternate embodiments may use any type of virtual hard disk in virtual store 604.

As shown in FIG. 6, virtual store 604 is separated into three quality of service levels (platinum, gold, and silver), which correspond to the three levels of quality of service discussed herein with respect to FIG. 4. Virtual store 604 is coupled to multiple storage nodes 618, 620, and 622 via a data communication network 624. Virtual Store 604 is created and managed by the virtual controller which also provides access to the host OS. Virtual store 604 physically resides on multiple storage nodes.

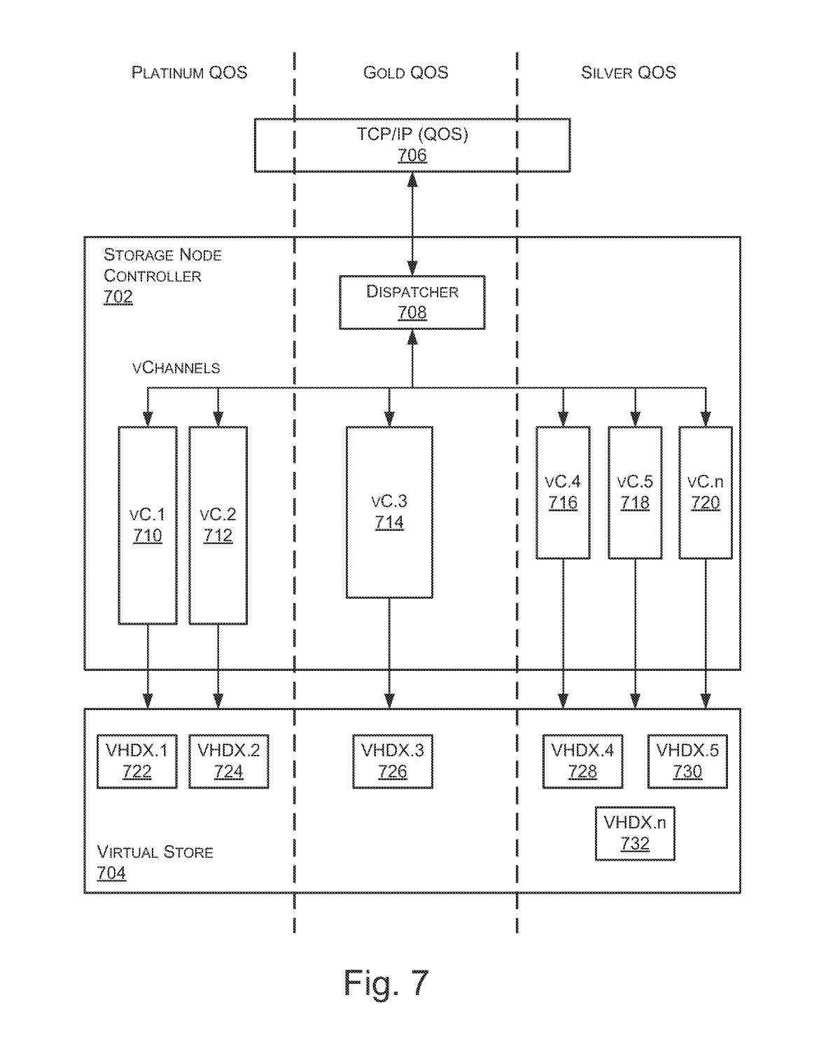

FIG. 7 is a block diagram depicting an embodiment of a storage node controller 702 and an associated virtual store 704 that provide multiple QOS levels for writing and retrieving data. Storage node controller 702 communicates with other devices and systems across a data communication network via TCP/IP (Transmission Control Protocol/Internet Protocol) 706. For example, storage node controller 702 may communicate via data communication network 210 discussed herein.

Storage node controller 702 includes a dispatcher 708 which binds a TCP/IP socket pair (connection) to a matching virtual channel and dispatches the network packets according to an associated service level (e.g., quality of service level).

Storage node controller 702 also includes six virtual channels 710, 712, 714, 716, 718, and 720. These six virtual channels correspond to similar virtual channels discussed herein, for example with respect to FIGS. 3 and 4. Virtual channels 710-720 are separated into three different quality of service levels (platinum, gold, and silver) as discussed herein. Virtual channels 710-720 correspond to six VHDX modules 722, 724, 726, 728, 730, and 732 included in virtual store 704. Thus the virtual channels provide “end-to-end” storage quality of service from the virtual machines (and associated applications) to the physical storage nodes. These systems and methods provide for improved data I/O processing and improved usage of system resources.

In some embodiments, a GridCache is implemented as part of one or more virtual controllers. The GridCache includes a local read cache that resides locally to the hypervisor on a local Flash Storage device (SSD or PCIe). When data writes occur, a copy of the updated I/O is left in the local read cache, and a copy is written to storage nodes that contain a persistent writeback flash device for caching writes before they are moved to a slower spinning disk media. Advantages of the Distributed Writeback Cache include:

Provides the fastest possible IO for both data read and data write operations.

Eliminates the need to replicate between flash devices within the host. This offloads the duplicate or triplicate write-intensive I/O operations from the hosts (e.g., computing devices).

Frees up local Flash storage capacity that would otherwise have been used for replica data from another host. Typically 1-2 replicas are maintained in the cluster.

This freed capacity can be used for a larger read cache, which increases the probability of cache hits (by 100%). This in turn increases performance by eliminating network I/O that is served from the local cache.

This increases performance of the overall system by eliminating the replica I/O from host to host.

This also increases system performance by eliminating the need to replicate I/O to another host and then write to primary storage (doubling the amount of I/O that must be issued from the original host). This additional I/O eliminates bandwidth and processing from original I/O.

Write I/O is accelerated by a persistent Write-back Cache in each storage node. I/O is evenly distributed across a plurality of storage nodes. Before leaving the host, write I/O is protected up to a predefined number of node failures using a forward error correction scheme. I/O that arrives at a storage node is immediately put into a fast persistent storage device and acknowledgement is sent back to the host the I/O has completed. The I/O can be destaged at any time from fast storage to a slower media such as a hard disk drive.

Due to virtual controller I/O Isolation and channeling of I/O, I/O priorities can also be used to govern cache utilization. Some I/O may never be cached if it is low priority, and high priority I/O will be retained longer in cache than lower priority I/O (using a class-based eviction policy). Policies can be applied at both ends of the I/O channel.

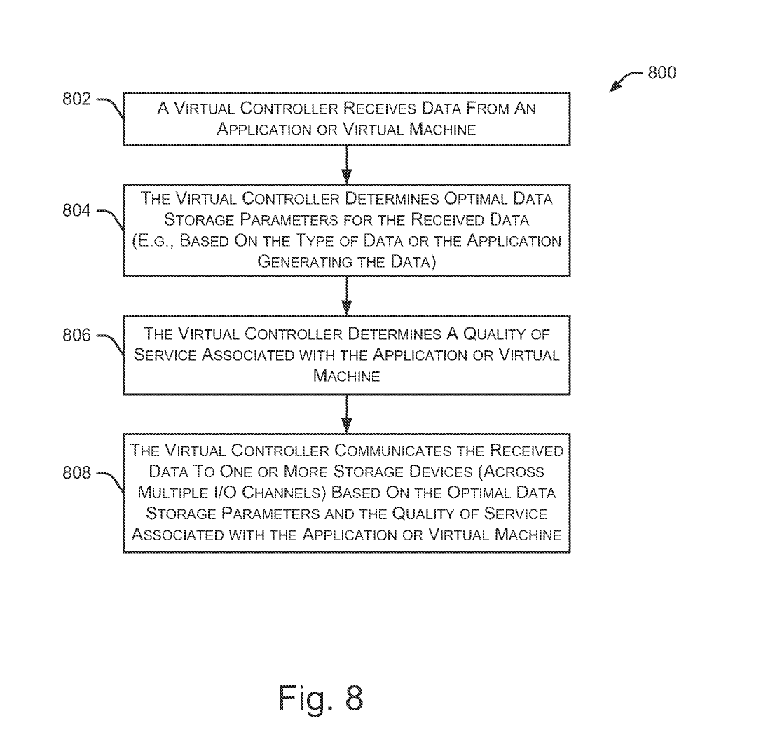

FIG. 8 is a flow diagram depicting an embodiment of a method 800 for managing the reading and writing of data. Initially, a virtual controller receives data from a virtual machine or an application running on a virtual machine at 802. The virtual controller then determines optimal data storage parameters for the received data at 804. For example, the optimal data storage parameters may be determined based on the type of data or the application generating the data, the type of I/O operation being performed, the saturation of the I/O channel, and the demand for storage resources. Next, the virtual controller determines a quality of service associated with the application or virtual machine at 806. Finally, the virtual controller communicates the received data to one or more storage devices (e.g., storage nodes) at 808. The data is communicated across multiple channels (i.e., virtual channels) based on the optimal data storage parameters and the quality of service associated with the application or virtual machine.

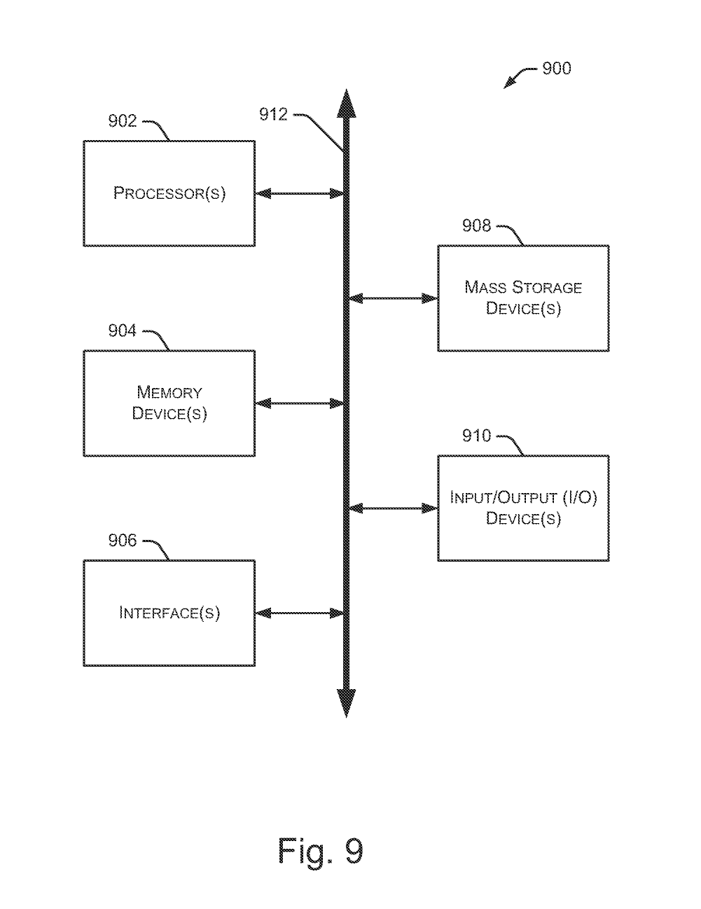

FIG. 9 is a block diagram depicting an example computing device 900. Computing device 900 may be used to perform various procedures, such as those discussed herein. Computing device 900 can function as a server, a client or any other computing entity. Computing device 900 can be any of a wide variety of computing devices, such as a desktop computer, a notebook computer, a server computer, a handheld computer, a tablet, and the like. In some embodiments, computing device 900 represents any of computing devices 202, 204, 206, and 300 discussed herein.

Computing device 900 includes one or more processor(s) 902, one or more memory device(s) 904, one or more interface(s) 906, one or more mass storage device(s) 908, and one or more Input/Output (I/O) device(s) 910, all of which are coupled to a bus 912. Processor(s) 902 include one or more processors or controllers that execute instructions stored in memory device(s) 904 and/or mass storage device(s) 908. Processor(s) 902 may also include various types of computer-readable media, such as cache memory.

Memory device(s) 904 include various computer-readable media, such as volatile memory (e.g., random access memory (RAM)) and/or nonvolatile memory (e.g., read-only memory (ROM)). Memory device(s) 904 may also include rewritable ROM, such as Flash memory.

Mass storage device(s) 908 include various computer readable media, such as magnetic tapes, magnetic disks, optical disks, solid state memory (e.g., Flash memory), and so forth. Various drives may also be included in mass storage device(s) 908 to enable reading from and/or writing to the various computer readable media. Mass storage device(s) 908 include removable media and/or non-removable media.

I/O device(s) 910 include various devices that allow data and/or other information to be input to or retrieved from computing device 900. Example I/O device(s) 910 include cursor control devices, keyboards, keypads, microphones, monitors or other display devices, speakers, printers, network interface cards, modems, lenses, CCDs or other image capture devices, and the like.

Interface(s) 906 include various interfaces that allow computing device 900 to interact with other systems, devices, or computing environments. Example interface(s) 906 include any number of different network interfaces, such as interfaces to local area networks (LANs), wide area networks (WANs), wireless networks, and the Internet.

Bus 912 allows processor(s) 902, memory device(s) 904, interface(s) 906, mass storage device(s) 908, and I/O device(s) 910 to communicate with one another, as well as other devices or components coupled to bus 912. Bus 912 represents one or more of several types of bus structures, such as a system bus, PCI bus, IEEE 1394 bus, USB bus, and so forth.

For purposes of illustration, programs and other executable program components are shown herein as discrete blocks, although it is understood that such programs and components may reside at various times in different storage components of computing device 900, and are executed by processor(s) 902. Alternatively, the systems and procedures described herein can be implemented in hardware, or a combination of hardware, software, and/or firmware. For example, one or more application specific integrated circuits (ASICs) can be programmed to carry out one or more of the systems and procedures described herein.

Although the present disclosure is described in terms of certain preferred embodiments, other embodiments will be apparent to those of ordinary skill in the art, given the benefit of this disclosure, including embodiments that do not provide all of the benefits and features set forth herein, which are also within the scope of this disclosure. It is to be understood that other embodiments may be utilized, without departing from the scope of the present disclosure.

1. An apparatus comprising:
one or more processors implementing a plurality of virtual machines, each of the plurality of virtual machines executing an application;
a virtual controller coupled to the one or more processors and configured to manage storage of data received from the plurality of virtual machines; and
a plurality of I/O channels configured to communicate data from the plurality of virtual machines to at least one data storage node based on data storage instructions received from the virtual controller.

2. The apparatus of claim 1, the virtual controller further configured to optimize storage of data received from each of the plurality of virtual machines based on the application generating the data.

3. The apparatus of claim 1, the virtual controller further configured to manage a quality of service associated with each of the plurality of virtual machines.

4. The apparatus of claim 1, wherein the plurality of I/O channels further communicate data from the plurality of virtual machines to a plurality of data storage nodes based on data storage instructions received from the virtual controller.

5. The apparatus of claim 1, further comprising a hypervisor associated with the plurality of virtual machines, wherein the virtual controller is coupled to the hypervisor.

6. A method comprising:
receiving, at a virtual controller, data from an application executed by a virtual machine;
determining, using one or more processors, optimal data storage parameters for the received data based on the type of data;
determining a quality of service associated with the application;
generating metadata that identifies the application generating the received data and the quality of service associated with the application;
associating the metadata with the received data; and
communicating the received data to at least one storage device based on the optimal data storage parameters and the quality of service associated with the application.

7. The method of claim 6, further comprising establishing a virtual channel associated with the received data.

8. The method of claim 7, wherein communicating the received data to at least one storage device includes communicating the received data using the virtual channel associated with the received data.

9. The method of claim 7, wherein the virtual channel is associated with a plurality of physical storage nodes.

10. A computing device comprising:
one or more processors implementing a plurality of virtual machines, each of the plurality of virtual machines executing an application;
a hypervisor configured to manage operation of the plurality of virtual machines; and
a virtual controller coupled to the hypervisor and configured to manage storage of data received from the plurality of virtual machines, the virtual controller further configured to create a virtual channel to communicate data from a particular application to at least one storage node using a service level associated with the particular application.

11. The computing device of claim 10, wherein the virtual controller is further configured to optimize storage of data from the particular application based on the service level associated with the particular application.

12. The computing device of claim 10, wherein the virtual controller is further configured to optimize storage of data from the particular application based on the type of data generated by the particular application.

13. The computing device of claim 10, wherein the service level associated with the particular application is a quality of service level.

14. The computing device of claim 10, wherein the virtual channel is associated with a plurality of storage nodes and data communicated on the virtual channel is stored across the plurality of associated storage nodes.

15. The computing device of claim 14, wherein the plurality of storage nodes are part of a shared storage system.

16. The computing device of claim 10, wherein the plurality of storage nodes are located in at least two different geographic locations.
